(19) United States
(12) Patent Application Publication
(10) Pub. No.: US 2006/0117576 A1
(43) Pub. Date: Jun. 8, 2006

(54) Cutlery implement

(75) Inventors: Brian Demers, Huntersville, NC (US); Joel Tetreault, Haskins, OH (US)

Correspondence Address: FOLEY AND LARDNER LLP;SUITE 500, 3000 K STREET NW, WASHINGTON, DC, 20007, US

(73) Assignee: Calphalon Corporation

(21) Appl. No.: 11/002,722

(22) Filed: Dec. 3, 2004

(51) Int. Cl. B25G 1/00

(52) U.S. Cl. 30/340

(57) ABSTRACT

A cutlery implement includes a blade, a handle and a bolster. The bolster is positioned at a balance point, in front of the back edge of the blade. The bolster has a tapered thickness to create a smooth transition from the blade to the handle. The bolster provides a more comfortable gripping portion, such that user may safely grip the cutlery implement at its balance point.

### BACKGROUND OF THE INVENTION

The present invention generally relates to cutlery, including knives and other utensils used in preparing food. More particularly, the invention relates to a cutlery device with a bolster that facilitates use and handling of the cutlery implement.

Cutlery devices such as knives are well known and are provided in various forms for particular uses. Generally, a knife has a blade portion at one end and a handle portion at an opposite end. A tang, which is typically formed integrally with the blade portion, extends into the handle portion and is surrounded by material that defines a predetermined or designated area where the knife can be held.

Generally, however, these areas do not provide the level of comfort and control that one needs when handling cutlery, consequently chefs and other food service professionals may often grasp the knife in a different manner. Specifically, professionals tend to grip a knife forward of the handle so that their hand is partially on the blade portion.

FIGS. 1A and 1B illustrate a prior art knife 1, and the hand position 8 utilized by a professional. As illustrated, the bolster 4 of the knife 1 generally dictates the hand position 8 of the user. The ideal hand position 8 for a user extends forward of the bolster area 4, partially on the blade portion 6. This places the hand slightly forward of the rear edge 10 of the blade portion 6. Specifically, the user grips the knife by placing the thumb and forefinger over the bolster and blade. The remaining three fingers of the hand wrap around the handle. Thus, the user still may experience discomfort and blistering because of where they must position their hand on the knife.

Generally, the bolster portion of a knife creates a hard edge. A user holding the knife with such a hard edge may experience pain and blistering after prolonged use of the knife. In addition, the hard edge of a bolster does not provide the user with an optimal safe and secure grip. To avoid this hard edge, a user may hold the knife in another area, which results in the user's hand not being centered across the length of the knife. Holding the knife off-center is likely to afford the user less control and result in inefficient use. Contour-shaped, ergonomic handles are known in the art. Such handles, however, are often thick and bulky and do not provide for comfortable use by consumers. Moreover, the handles known in the art are not as comfortable when gripped between the thumb and forefinger over the bolster and the blade, as is typical for professional users.

One known cutlery knife has a blended bolster area, that is a bolster that has a more tapered edge. The bolster is located past the rear edge of the blade, closer to the handle. Due in part to the bolster's position, this knife has several drawbacks because the ability to control the knife still requires the user to grip a substantial amount of the blade area, which is typically thinner and thus harder to grip.

As a result, there is a need for a cutlery implement that has a bolster that allows the user to effectively control the knife while limiting discomfort. More specifically, it is desirable to provide cutlery with a bolster that is comfortable for both professional and ordinary consumers, that is cutlery that may be gripped comfortably by either lay users or professional users.

### SUMMARY OF THE INVENTION

According to a first aspect of the invention, a cutlery implement is provided. The cutlery implement includes a blade portion having a rear edge. A handle portion is connected to the blade portion. The cutlery implement also includes a bolster portion located between the blade portion and the handle portion wherein the bolster portion is disposed forward of the rear edge of the blade. The bolster is formed so as to provide an ergonomic gripping position.

According to another aspect of the invention, the bolster portion is positioned at a balancing point between the blade portion and the handle portion.

According to yet another aspect of the invention the bolster portion includes a first side face and a second side face opposing the first side face.

According to still another aspect of the invention, the bolster portion has a tapered thickness, creating a gripping position so that a user may comfortably hold the cutlery implement at the gripping position. The bolster portion is tapered from a rearward end nearer the handle portion to a forward end nearer the forward end of the blade portion.

According to yet another aspect of the invention, the bolster portion's first side face is opposite the second side face and the first side face and second side face each have a concave, curved surface extending along the bolster portion's length from the blade portion to the handle portion.

According to another aspect of the invention, the first side face and second side face are tapered from a rearward end nearer the handle portion to a forward end nearer the blade portion, such that the cross sectional area of the bolster portion decreases from the rearward end to a forward end along the length of the bolster portion.

Preferably, the first side face and the second side face of the bolster portion are complimentary. The handle portion is preferably created using an injection molding process.

Preferably, the blade portion, and the bolster portion are created from a single piece of metal. This metal may be steel, layered in a Damascus pattern. In still another aspect of the invention, the blade portion and the bolster portion are comprised of a single piece of forged metal.

Another aspect of the invention includes a method for providing a cutlery implement and gripping the cutlery implement by holding the bolster portion between a thumb and a forefinger at the position forward the rear edge of the blade portion.

It is to be understood that both the foregoing general description and the following detailed description are exemplary and explanatory only, and are not restrictive of the invention as claimed.

### BRIEF DESCRIPTION OF THE DRAWINGS

These and other features, aspects and advantages of the present invention will become apparent from the following description, appended claims, and the accompanying exemplary embodiments shown in the drawings, which are briefly described below.

FIG. 1A is a top view of a prior art cutlery implement.

FIG. 1B is a side view of a prior art cutlery implement.

FIG. 2 is a side view of a cutlery implement according to an embodiment of the present invention.

FIGS. 3(a)-3(e) are cross sectional views of the bolster portion 300 illustrated in FIG. 2.

FIG. 4 is a top view of the cutlery implement of FIG. 2.

FIG. 5 is a bottom view of the cutlery implement of FIG. 2.

FIG. 6 is a front view of the cutlery implement of FIG. 2.

FIG. 7 is a back view of the cutlery implement of FIG. 2.

FIG. 8 is a perspective view of the cutlery implement of FIG. 2.

FIG. 9 is a top view of the cutlery implement of FIG. 2.

FIG. 10A is a perspective view of a paring knife according to another embodiment of the present invention.

FIG. 10B is a top view of a paring knife according to another embodiment of the present invention.

FIG. 10C is a side view of a paring knife according to another embodiment of the present invention.

FIG. 10D is a back view of a paring knife according to another embodiment of the present invention.

FIG. 11A is a perspective view of a serrated knife according to another embodiment of the present invention.

FIG. 11B is a top view of a serrated knife according to another embodiment of the present invention.

FIG. 11C is a side view of a serrated knife according to another embodiment of the present invention.

FIG. 11D is a back view of a serrated knife according to another embodiment of the present invention.

FIG. 12A is a perspective view of a santoku knife according to another embodiment of the present invention.

FIG. 12B is a top view of a santoku knife according to another embodiment of the present invention.

FIG. 12C is a side view of a santoku knife according to another embodiment of the present invention.

FIG. 12D is a back view of a santoku knife according to another embodiment of the present invention.

FIG. 13A is a perspective view of a forked knife according to another embodiment of the present invention.

FIG. 13B is a top view of a forked knife according to another embodiment of the present invention.

FIG. 13C is a side view of a forked knife according to another embodiment of the present invention.

FIG. 13D is a back view of a forked knife according to another embodiment of the present invention.

FIG. 14A is a perspective view of a nakiri knife according to another embodiment of the present invention.

FIG. 14B is a top view of a nakiri knife according to another embodiment of the present invention.

FIG. 14C is a side view of a nakiri knife according to another embodiment of the present invention.

FIG. 14D is a back view of a nakiri knife according to another embodiment of the present invention.

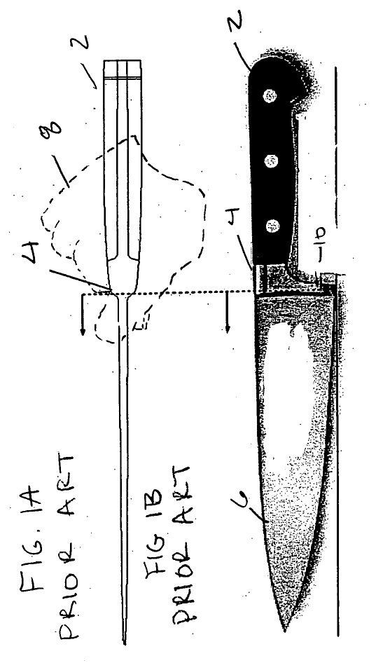

### DETAILED DESCRIPTION OF THE PREFERRED EMBODIMENTS

Embodiments of the present invention will be described below with reference to the accompanying drawings. It should be understood that the following description is intended to describe exemplary embodiments of the invention, and not to limit the invention.

FIG. 2 shows a cutlery implement 100 according to an exemplary embodiment of the present invention, specifically a chef's knife. The cutlery implement 100 includes a blade portion 200, a bolster portion 300 and a tang 400 enclosed in a handle portion 500. The blade portion 200 has at least one point 210, a cutting surface 220, a top edge 230 opposite the cutting surface 220 and a rear edge 240 opposite the point 210. The bolster portion 300 is formed so as to provide an ergonomic gripping position.

Located within the handle 500 is a tang 400 that extends substantially along the entire length of the handle 500. A bolster portion 300 is located between the tang 400 and the blade portion 200. In one aspect of the present invention, the blade portion 200, the bolster portion 300 and the tang 400 are formed from a single piece of metal. Alternatively, the tang 400 may be welded to the blade portion 200.

The handle portion 500 may be formed in an injection molding process wherein the plastic material is injected into a mold surrounding the tang 400. Preferably, the blade portion 200 is made from a core piece of VG-10 steel in which 16 to 32 layers of steel are folded over in a layered pattern creating a unique pattern called Damascus. The handle portion 500 is then injected and the blade portion 200 is polished.

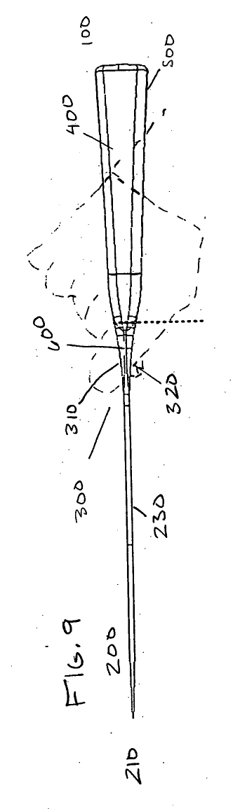

According to another aspect of the invention, the bolster portion 300 is configured to provide a comfortable fit for the user. As seen in FIG. 9, an experienced chef will typically hold a cutlery implement at a balance point 600 with the thumb and forefinger extending over the bolster portion 300 and blade portion 200. The remaining three fingers of the hand will wrap around the handle portion 500.

According to one aspect of the invention, the bolster portion 300 is positioned forward of the rear edge 240. That is, in moving from the blade's point 210 to the tang 400, the bolster portion 300 is positioned before the rear edge 240. This allows a professional to hold the cutlery implement 100 comfortably at the balance point 600. The bolster portion 300 has a smooth tapered surface which joins the tang 400 and the blade portion 200 in a curved manner.

According to still yet another aspect of the invention, the bolster portion 300 is located at a position forward of the balancing point 600. Preferably, the bolster portion 300 has a cross sectional area such that the bolster portion's 300 cross sectional area along the top of the blade portion 230 is greater that the bolster portion's 300 cross sectional area along the cutting surface of the blade portion 220.

As seen in FIG. 4, the bolster portion 300 of the exemplary embodiment has a first side face 310 and a second side face 320 located opposite each other. The first side face has a concave curve along at least a portion of the bolster portion's 300 length. In addition, the second side face 320 has a concave curve along at least a portion of the bolster portion's 300 length. Preferably, the first side face 310 and the second side face 320 are complimentary.

As illustrated, the first side face 310 and the second side face 320 are tapered from a rearward end near the tang 400 to a forward position where the bolster portion 300 blends with the blade portion 200 at a point forward of the rear edge 240. The cross-sectional area of the bolster portion 300 gradually decreases from the rearward position near the tang 400 to the forward position along the length of the bolster portion 300. In still yet another aspect of the invention, the side faces of the bolster 310, 320 are sandblasted to improve the finish and promote gripping. In another aspect of the invention the side faces of the bolster 310, 320 are polished.

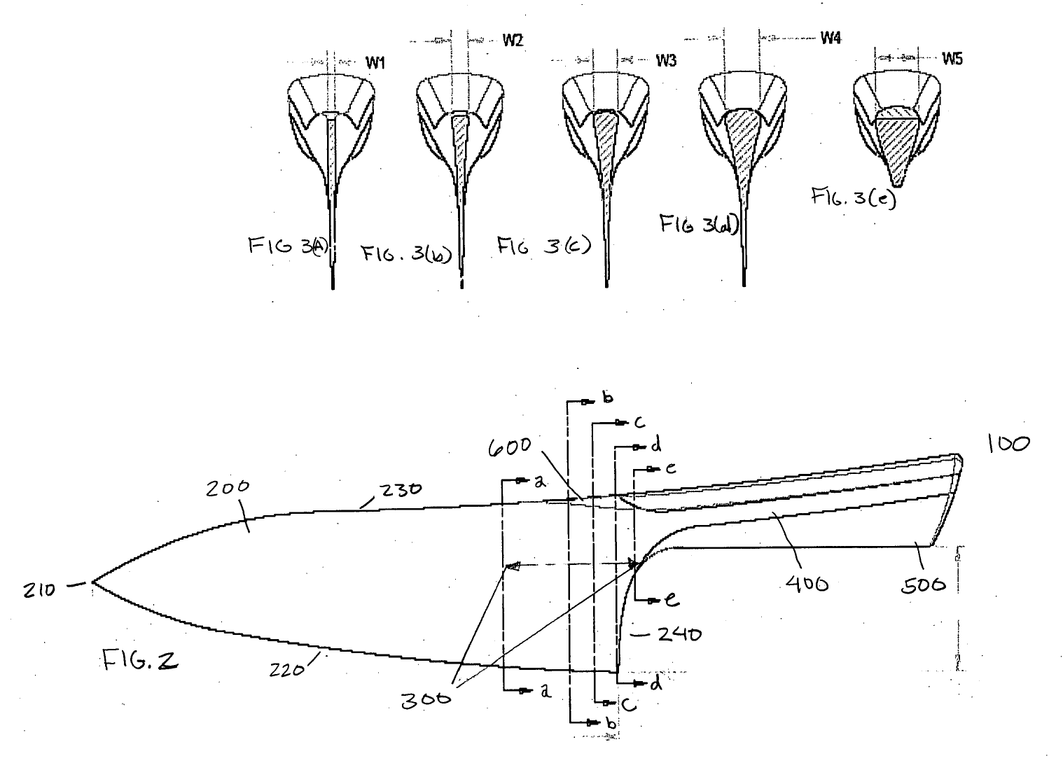

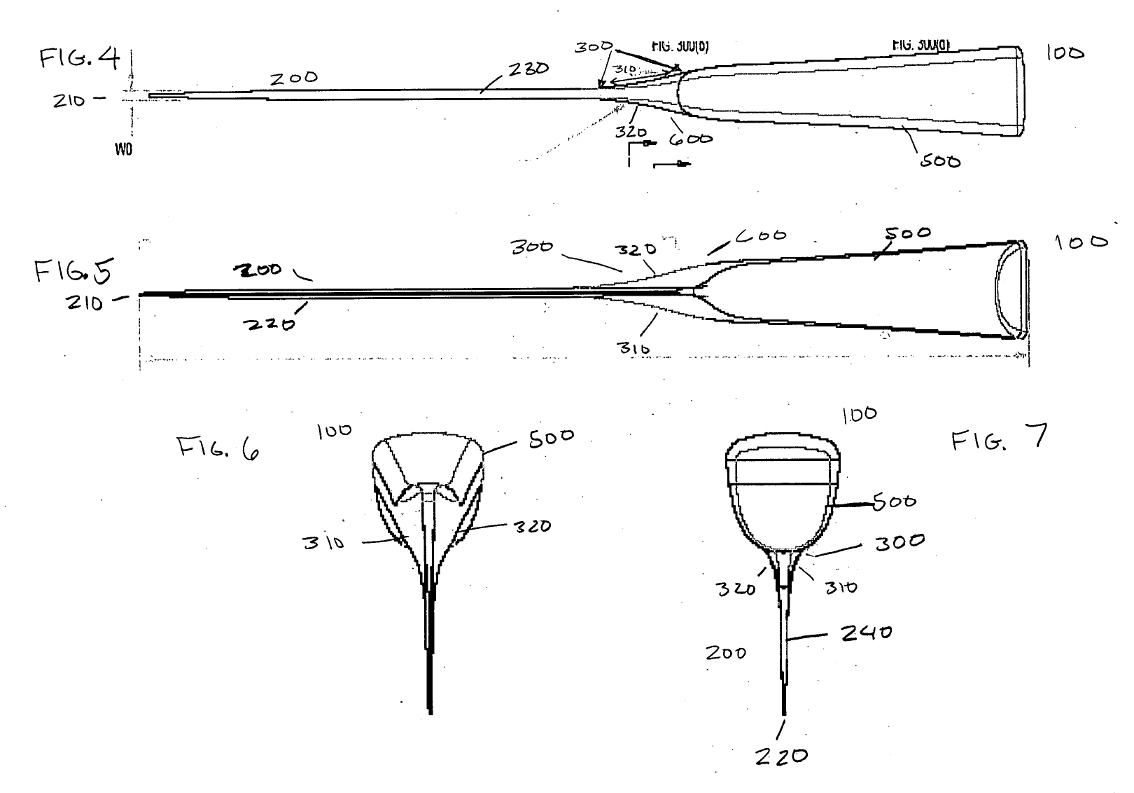

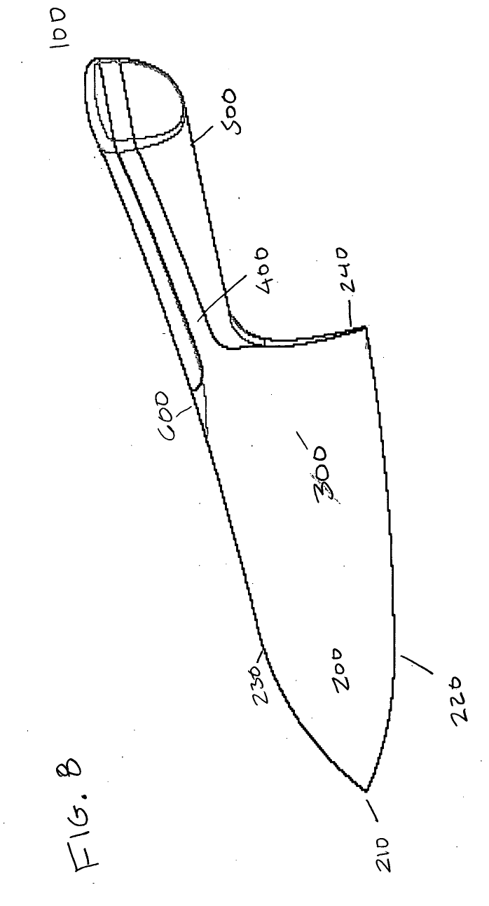

As noted, the bolster portion 300 may have a tapered thickness. The cross-sectional area of the bolster portion 300 as seen in FIGS. 3(a)-3(e) is largest toward the rear of the bolster portion 300 where it joins the tang 400. Along the length of the bolster portion 300 the cross sectional area of the bolster portion 300 gradually decreases in the direction toward the point 210 creating a gripping position. The bolster portion 300 blends smoothly with the blade portion 200.

Specifically, along the top edge 230 and at cross section 3(e) the bolster portion 300 has a width W5. The width W4 of the bolster portion 300, along the top edge 230 at cross section 3(d) is less than width W5. Similarly, the width W3 of the bolster portion 300, along the top edge 230 at cross section 3(c) is less than width W4. The width W2 of the bolster portion 300, along the top edge 230 at cross section 3(b) is less than width W3. Similarly, the width W1 of the bolster portion 300 at cross section 3(a) along the top edge 230 is less than the width W5 of the bolster portion 300 at cross section 3(e). While the invention is not yet limited to specific dimensions, in an exemplary chef's knife the width of the bolster portion 300 along the top edge of the blade portion 230 from cross section 3(a) to 3(e) is in the range of 0.097 inches to 0.539 inches, specifically 0.97 inches at W1, 0.211 inches at W2, 0.313 inches at W3, 0.442 inches at W4 and 0.539 inches at W5.

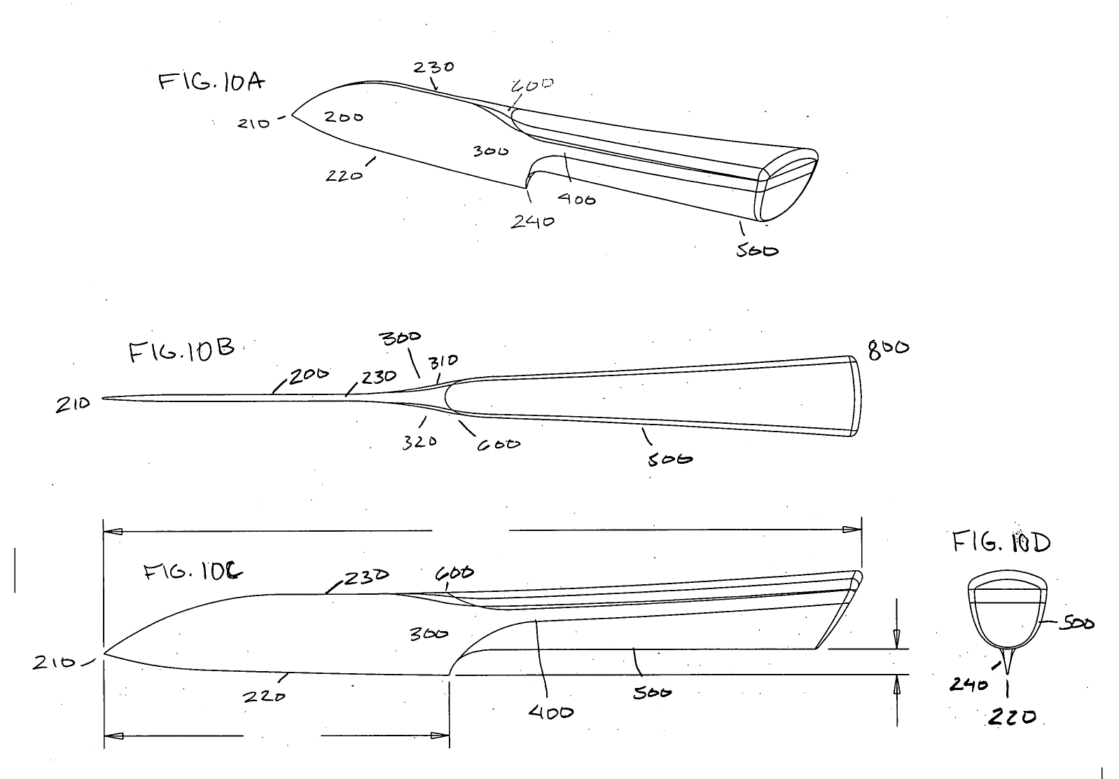

While a chef's knife is illustrated in the above-described embodiments, it will be appreciated that other sizes and types of knives may employ a bolster using the principles of the present invention. For example, as seen in FIG. 10A, according to an aspect of the present invention, a paring knife 800 has a bolster portion 300 located forward of the back edge 240. In one aspect of the invention the pairing knife 800 has a cutting surface 220 that is well suited for peeling and removing cores from fruit or vegetables.

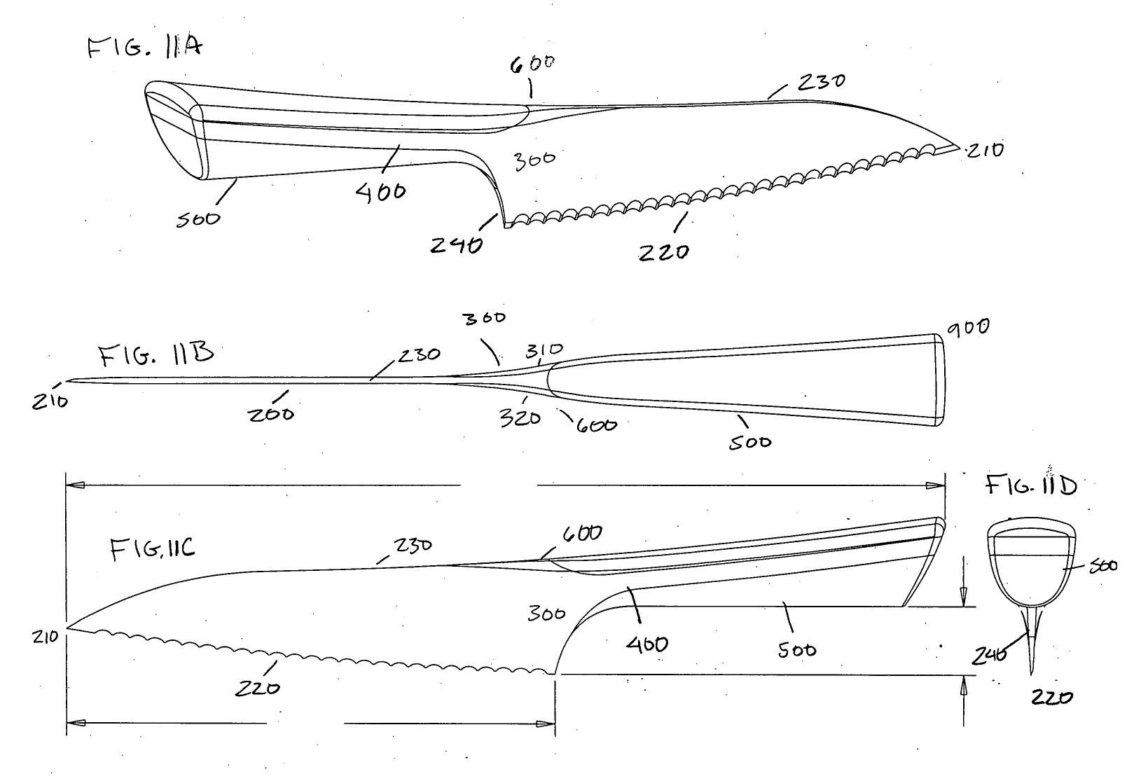

As seen in FIG. 11A, in yet another aspect of the invention, a serrated knife 900 has a bolster portion 300 located forward of the rear edge of the blade 240. The serrated knife 900 has a serrated cutting surface 220 and is well suited for use on soft objects such as bread, tomatoes and cake.

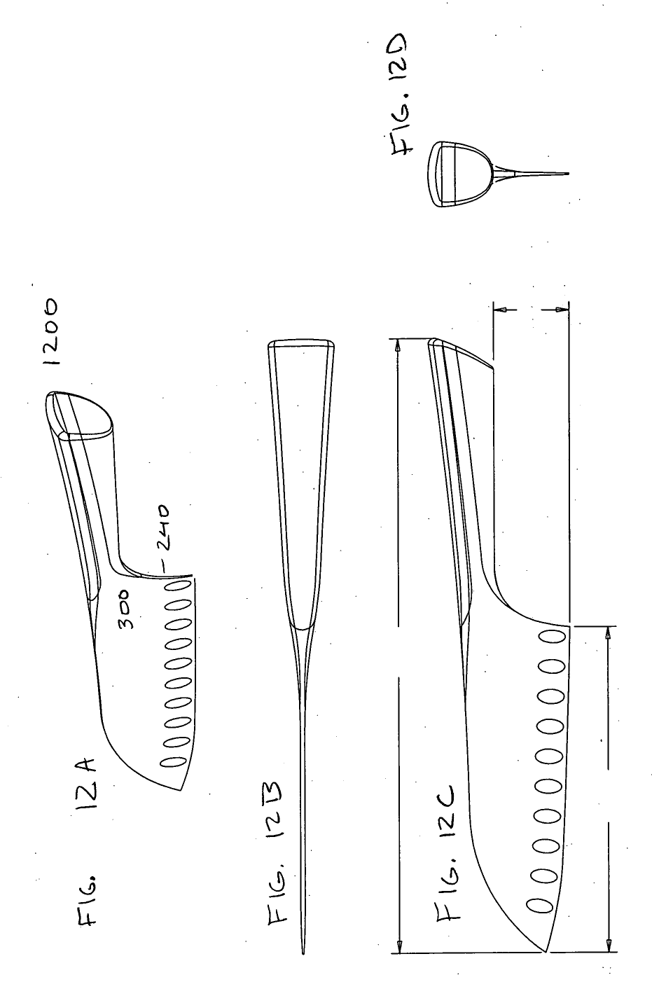

FIG. 12A illustrates, according to another embodiment of the present invention, a santoku knife 1200 that has a bolster portion 300 located forward of the rear edge 240.

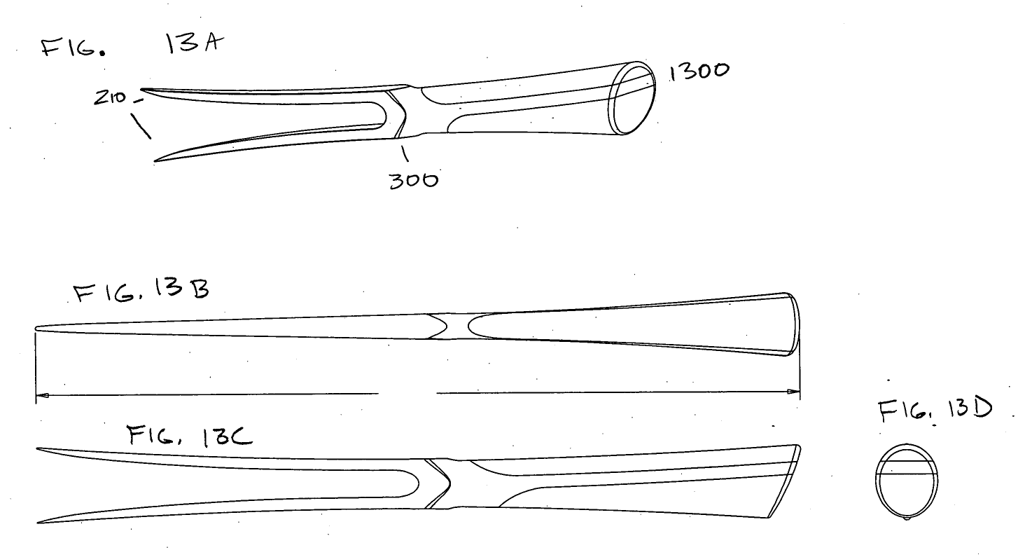

As seen in FIG. 13A, according to another embodiment of the present invention, a forked knife 1300 has two points 210 and a bolster portion 300 located forward of the handle 500.

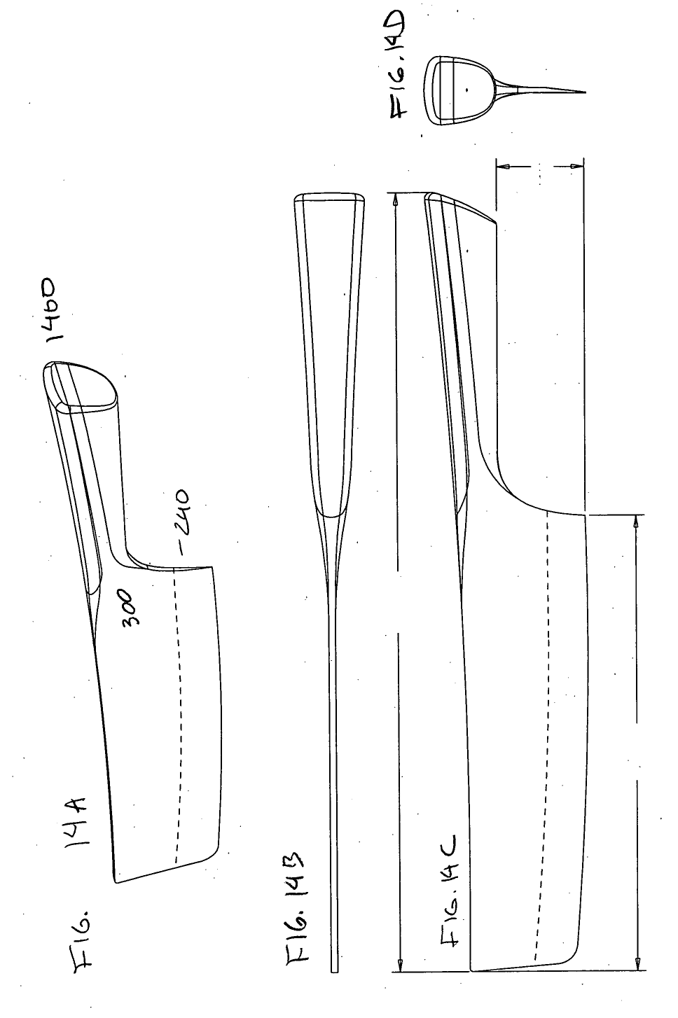

FIG. 14A illustrates, according to another embodiment of the present invention, a nakiri knife 1400 that has a bolster portion 300 located forward of the rear edge 240.

According to certain aspects of the present invention, several advantages are realized. One advantage is that the user experiences comfort and control when gripping the present invention. In addition, certain aspects of the invention aide in minimizing hand fatigue, pain, soreness and blistering. Moreover, certain aspects of the present invention allow the user to hold the cutlery implement safely and securely at its balance point.

The foregoing description illustrates various aspects, features and advantages of the invention. Among other features, the invention provides cutlery having a bolster that is comfortable for users.

Given the disclosure of the present invention, one versed in the art would appreciate that there may be other embodiments and modifications within the scope and spirit of the invention. Accordingly, all modifications attainable by one versed in the art from the present disclosure within the scope and spirit of the present invention are to be included as further embodiments of the present invention. The scope of the present invention is to be defined as set forth in the following claims.

What is claimed is:

1. A cutlery implement comprising:
a blade portion, having a rear edge;
a handle portion connected to the blade portion; and
a bolster portion, located between the blade portion and the handle portion, wherein the bolster portion is disposed forward of the rear edge of the blade portion.

2. A cutlery implement of claim 1, wherein the bolster portion is positioned at a balancing point between the blade portion and the handle portion.

3. A cutlery implement of claim 1, wherein the bolster portion includes a first side face and a second side face opposing the first side face.

4. A cutlery implement of claim 1, wherein the bolster portion has a tapered thickness creating a gripping position whereby a person may comfortably hold the cutlery implement at the gripping position.

5. A cutlery implement of claim 4, wherein the bolster portion is tapered from a rearward end nearer the handle to a forward end nearer the forward end of the blade portion.

6. A cutlery implement of claim 3, wherein the first side face and the second side face each have a concave, curved surface extending along its length from the blade portion to the handle portion.

7. A cutlery implement of claim 6, wherein the first side face and second side face are tapered from a rearward end near the handle portion to a forward end near the blade portion such that the cross sectional area of the bolster portion decreases from the rearward end to the forward end along the length of the bolster portion.

8. A cutlery implement of claim 6, wherein the first side face and second side face are complimentary.

9. A cutlery implement of claim 1, wherein the handle portion is attached to a tang portion formed integrally with the blade portion.

10. A cutlery implement of claim 9, wherein the handle portion is created by an injection molding process.

11. A cutlery implement of claim 9, wherein the blade portion, the bolster portion and the tang portion are parts of a single piece of metal.

12. A cutlery implement of claim 11, wherein the blade portion is a core piece of layered steel.

13. A cutlery implement of claim 12, wherein the blade portion is forged with 16 to 32 layers of steel, folded over in a layered Damascus pattern.

14. A cutlery implement of claim 9, wherein the blade portion is welded to the tang portion.

15. A cutlery implement of claim 1, wherein the blade portion and the tang portion are comprised of forged steel.

16. A cutlery implement comprising:
a blade portion;
a handle portion; and
a bolster portion located forward of the back edge of the blade portion, having a tapered thickness such that the cross sectional area of the bolster portion decreases from a rearward end of the bolster portion to a forward end of the bolster portion along the length of the bolster portion whereby the bolster portion tapers into the blade portion and creates a gripping position at a balancing point of the cutlery implement.

17. A method of utilizing a knife comprising:
providing a cutlery implement according to claim 1; and
gripping the cutlery implement by holding the bolster portion between a thumb and a forefinger at the position forward the rear edge of the blade portion.

18. A method of utilizing a cutlery implement, comprising:
providing a cutlery implement according to claim 16; and
gripping the cutlery implement by holding the bolster portion between a thumb and a forefinger at the position forward the rear edge of the blade portion.
